(19) United States
(12) Patent Application Publication
(10) Pub. No.: US 2010/0307373 A1
(43) Pub. Date: Dec. 9, 2010

(54) Containment Systems for Use With Railcars

(76) Inventors: Robert Joseph Kinsella, O'Fallon, IL (US); Michael Shaun Peoples, Marthasville, MO (US)

Correspondence Address: Patent Docket Department;Armstrong Teasdale LLP, 7700 Forsyth Boulevard, Suite 1800, St. Louis, MO, 63105, US

(21) Appl. No.: 12/792,638

(22) Filed: Jun. 2, 2010

Related U.S. Application Data
(60) Provisional application No. 61/183,831, filed on Jun. 3, 2009.

(51) Int. Cl. B61D 5/00; B23P 17/04

(52) U.S. Cl. 105/358; 29/428

(57) ABSTRACT

A pressurized tanker railcar is provided. The pressurized tanker railcar includes an inner tank configured to contain a substance therein, an outer jacket configured to define an outer surface of the pressurized tanker railcar, and a containment system positioned between the inner tank and the outer jacket. The containment system is coupled to the inner tank and is configured to at least one of substantially resist penetration of the inner tank by a projectile and seal an opening formed by the projectile penetrating the inner tank.

### CROSS-REFERENCE TO RELATED APPLICATIONS

This application claims the priority of U.S. Provisional Patent Application Ser. No. 61/183,831, filed Jun. 3, 2009, which is hereby incorporated by reference in its entirety.

### BACKGROUND OF THE INVENTION

The embodiments described herein relate generally to containment systems for use with tanker railcars and, more particularly, to containment systems for use with pressurized tanker railcars.

The transportation industry transports a variety of products, including hazardous products, in many different types of transport vehicles. For example, fuel, gases, and/or other hazardous chemicals are contained in tanker vehicles, such as over-the-road trucks and railcars. Truck tanks are minimally pressurized to about 3 pounds per square inch (psi) above atmospheric pressure and are considered to be non-pressurized tanks. In contrast, railcar tanks can be pressurized to relatively high pressures, such as pressures between about 165 psi and about 700 psi above atmospheric pressure. Railcar tanks can also operate at pressures lower than 165 psi. These truck and train tanks may be impacted by projectiles while storing and/or transporting hazardous chemicals. It is important to protect these tanks from projectiles or otherwise minimize the risk of leaking these hazardous chemicals, which could cause serious harm.

At least some known truck tankers include self-sealing coatings that allow a projectile to enter the truck tank, but self-seal as the projectile passes through the coating. However, known truck tanks that include self-sealing coating are non-pressurized vessels, and the self-sealing coatings used on these known truck tankers would not effectively seal a tank at higher pressures. Further, self-sealing coatings for truck tanks are configured to react with fuels to facilitate the self-sealing aspect; however, railcar tanks often store and/or transport hazardous materials other than fuel, such as chlorine or anhydrous ammonia. As such, the self-sealing coatings for known truck tanks would not be effective with many of the materials transported in train tanks.

### BRIEF DESCRIPTION OF THE INVENTION

In one aspect, a pressurized tanker railcar is provided. The pressurized tanker railcar includes an inner tank configured to contain a substance therein, an outer jacket configured to define an outer surface of the pressurized tanker railcar, and a containment system positioned between the inner tank and the outer jacket. The containment system is coupled to the inner tank and is configured to at least one of substantially resist penetration of the inner tank by a projectile and seal an opening formed by the projectile penetrating the inner tank.

In another aspect, a method for forming a pressurized tanker railcar is provided. The method includes providing an inner tank configured to contain a substance therein and coupling a containment system about the inner tank. The containment system is configured to at least one of substantially resist penetration of the inner tank by a projectile and seal an opening formed by the projectile penetrating the inner tank. The method further includes coupling an outer jacket about the containment system. The outer jacket defines an outer surface of the pressurized tanker railcar.

In still another aspect, a pressurized tanker railcar is provided. The pressurized tanker railcar includes an inner tank configured to contain a substance therein and a containment system positioned about the inner tank. The containment system is coupled to the inner tank and is configured to at least one of substantially resist penetration of the inner tank by a projectile and seal an opening formed by the projectile penetrating the inner tank.

### BRIEF DESCRIPTION OF THE DRAWINGS

FIGS. 1-10 show exemplary embodiments of the systems described herein.

FIG. 1 is a side view of an exemplary high-pressure tanker railcar.

FIG. 2 is a partial cross-sectional view of the high-pressure tanker railcar shown in FIG. 1 taken at line 2-2.

FIG. 3 is a side view of an exemplary low-pressure tanker railcar.

FIG. 4 is a partial cross-sectional view of the low-pressure tanker railcar shown in FIG. 3 taken at line 4-4.

FIG. 5 is a partial cross-sectional view of an exemplary embodiment of a containment system for use with the high-pressure tanker railcar shown in FIG. 1 taken at section A.

FIG. 5A is an enlarged schematic illustration of a portion of the containment system shown in FIG. 5 taken at section 5A.

FIG. 6 is a partial cross-sectional view of an exemplary embodiment of a containment system for use with the low-pressure tanker railcar shown in FIG. 3 taken at section B.

FIG. 6A is an enlarged schematic illustration of a portion of the containment system shown in FIG. 6 taken at section 6A.

FIG. 7 is a partial cross-sectional view of a first alternative embodiment of a containment system for use with the high-pressure tanker railcar shown in FIG. 1 taken at section A.

FIG. 7A is an enlarged schematic illustration of a portion of the containment system shown in FIG. 7 taken at section 7A.

FIG. 8 is a partial cross-sectional view of a first alternative embodiment of a containment system for use with the low-pressure tanker railcar shown in FIG. 3 taken at section B.

FIG. 9 is a partial cross-sectional view of a second alternative embodiment of a containment system for use with the high-pressure tanker railcar shown in FIG. 1 taken at section A.

FIG. 10 is a partial cross-sectional view of a second alternative embodiment of a containment system for use with the low-pressure tanker railcar shown in FIG. 3 taken at section B.

### DETAILED DESCRIPTION OF THE INVENTION

The embodiments described herein facilitate preventing hazardous materials, such as, but limited to, fuel, chlorine gas, and/or anhydrous ammonia, from being released from a tanker railcar. More specifically, if a tanker railcar is impacted by a projectile, such as a bullet, shrapnel, a rock, and/or other object, the containment systems described herein facilitate preventing the hazardous material from being released into the surroundings from the tanker railcar at the point of impact. The projectile described herein could include an object that is intentionally fired at the tanker railcar or an object that unintentionally impacts the tanker railcar as a result of an accident involving the tanker railcar.

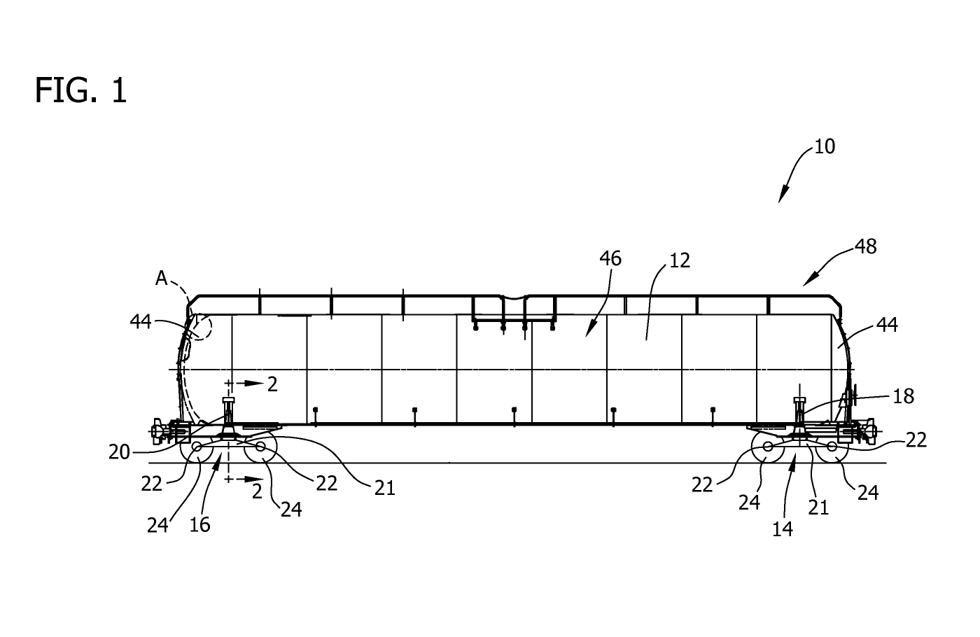

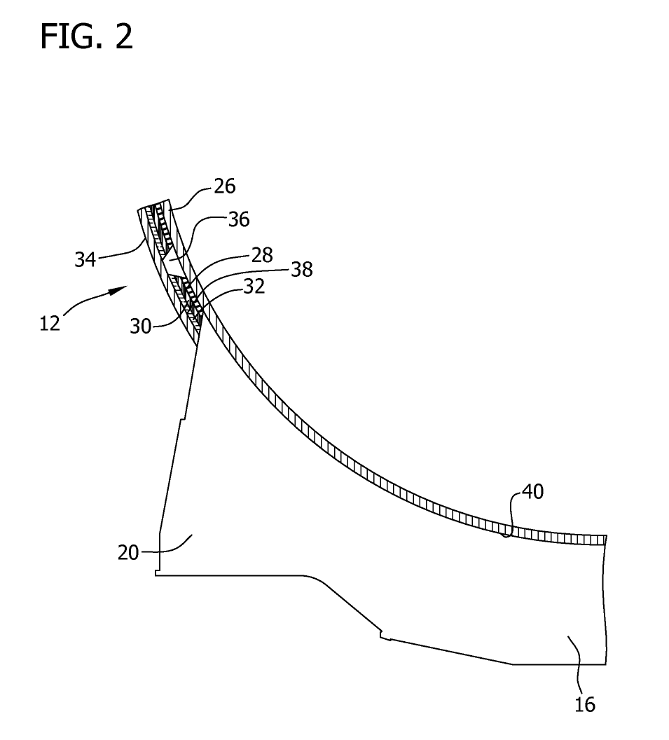

FIG. 1 is a side view of an exemplary high-pressure tanker railcar 10. FIG. 2 is a partial cross-sectional view of high-pressure tanker railcar 10 taken at line 2-2. High-pressure tanker railcar 10 is configured to be pressurized to between about 165 psi and about 700 psi above atmospheric pressure and, more particularly, between about 300 psi and about 450 psi above atmospheric pressure and is used to store and/or transport materials, such as chlorine and/or anhydrous ammonia. High-pressure tanker railcar 10 includes a tank 12, a front sill assembly 14, and a rear sill assembly 16. Sill assemblies 14 and 16 are coupled to tank 12. Bolster assemblies 18 and 20 are configured to stabilize tank 12 on sill assemblies 14 and 16. More specifically, front bolster assembly 18 is coupled to tank 12 and front sill assembly 14, and rear bolster assembly 20 is coupled to tank 12 and rear sill assembly 16. Each sill assembly 14 and 16 includes a truck 21 having a pair of axles 22 each coupled to a pair of wheels 24.

In the exemplary embodiment, tank 12 includes an inner tank 26, a containment system 28, a fire retardant layer 30, an insulation layer 32, and an outer jacket 34. Containment system 28 is coupled or applied to inner tank 26 and/or formed integrally as one-piece with inner tank 26. Further, in some embodiments, containment system 28 can have fire retardant and/or insulation properties such that tank 12 does not include fire retardant layer 30 and/or insulation layer 32. In the exemplary embodiment, containment system 28 is configured to substantially resist penetration of inner tank 26 by projectiles and/or to repair damage caused by projectiles penetrating inner tank 26. Alternatively or additionally, containment system 28 is configured to provide a desired insulation rating and/or level for inner tank 26.

Stand-offs 36 are, in the exemplary embodiment, coupled to inner tank 26 to facilitate coupling outer jacket 34 to inner tank 26. More specifically, stand-offs 36 are welded and/or otherwise coupled to inner tank 26 and extend through containment system 28, fire retardant layer 30, and insulation layer 32 to an inner surface 38 of outer jacket 34. As such, stand-offs 36 are welded to inner surface 38 of outer jacket 34. Bolster assemblies 18 and 20 are coupled to an outer surface 40 of inner tank 26.

To manufacture high-pressure tanker railcar 10, inner tank 26, bolster assemblies 18 and 20, and sill assemblies 14 and 16 are assembled. More specifically, bolster assemblies 18 and 20 and sill assemblies 14 and 16 are welded and/or otherwise couple to inner tank 26. Stand-offs 36 are coupled to outer surface 40 of inner tank 26. Containment system 28 is coupled to, applied to, and/or formed integrally with inner tank 26. Fire retardant layer 30 is coupled about containment system 28, and insulation layer 32 is coupled about fire retardant layer 30. Outer jacket 34 is then coupled about insulation layer 32 by coupling inner surface 38 of outer jacket 34 to stand-offs 36. Bolster assemblies 18 and 20 and sill assemblies 14 and 16 are then rested on trucks 21.

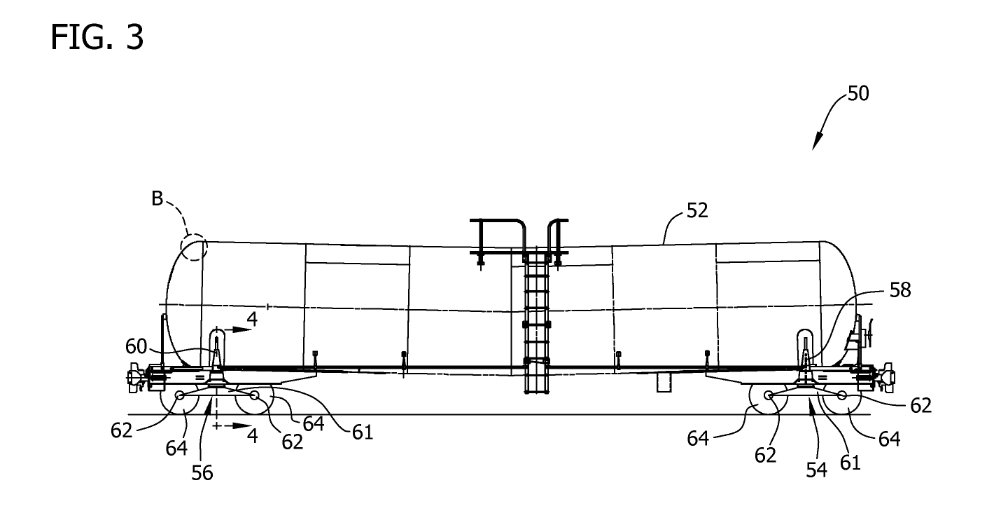

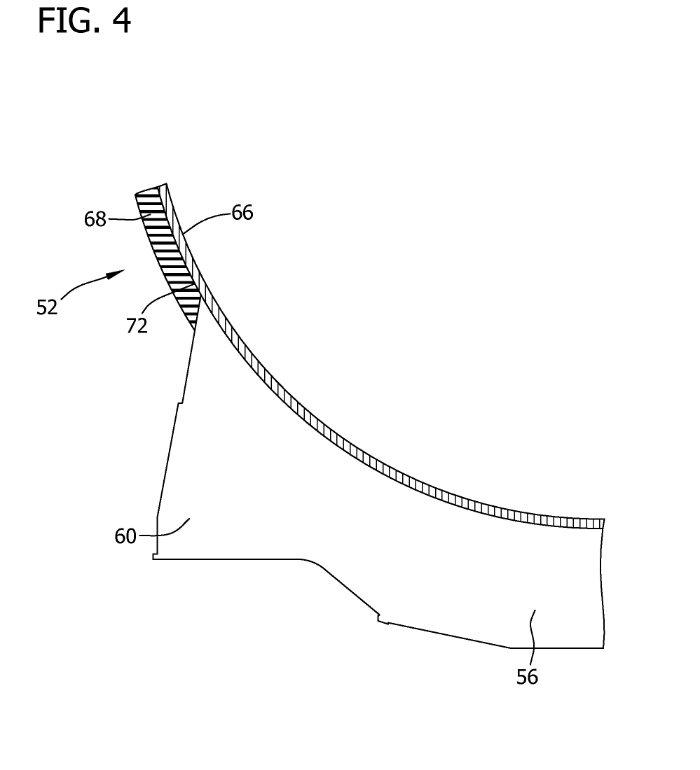

FIG. 3 is a side view of an exemplary low-pressure tanker railcar 50. FIG. 4 is a partial cross-sectional view of low-pressure tanker railcar 50 taken at line 4-4. Low-pressure tanker railcar 50 is configured to be pressurized up to about 165 psi above atmospheric pressure and is used to store and/or transport materials, such as ethanol and/or other commodities. Low-pressure tanker railcar 50 includes a tank 52, a front sill assembly 54, and a rear sill assembly 56. Sill assemblies 54 and 56 and bolster assemblies 58 and 60 are coupled to tank 52. More specifically, front bolster assembly 58 is coupled to tank 52 and front sill assembly 54, and rear bolster assembly 60 is coupled to tank 52 and rear sill assembly 56. Each sill assembly 54 and 56 includes a truck 61 having a pair of axles 62 each coupled to a pair of wheels 64.

In the exemplary embodiment, tank 52 includes an inner tank 66 and a containment system 68. Containment system 68 is coupled or applied to inner tank 66 and/or formed integrally as one-piece with inner tank 66. In the exemplary embodiment, containment system 68 is configured to substantially resist penetration of inner tank 66 by projectiles and/or to repair damage caused by projectiles penetrating inner tank 66. Further, because containment system 68 is coupled about inner tank 66, bolster assemblies 58 and 60, and sill assemblies 54 and 56, containment system 68 is configured to be painted such that numbering, lettering, and/or other identifying marks can be applied to tank 52. In certain embodiments, containment system 68 is configured to alternatively or additionally insulate inner tank 66.

To manufacture low-pressure tanker railcar 50 in the exemplary embodiment, inner tank 66, bolster assemblies 58 and 60, and sill assemblies 54 and 56 are assembled. Containment system 68 is coupled to, applied to, and/or formed integrally with inner tank 66. Bolster assemblies 58 and 60 and sill assemblies 54 and 56 are then rested on trucks 61.

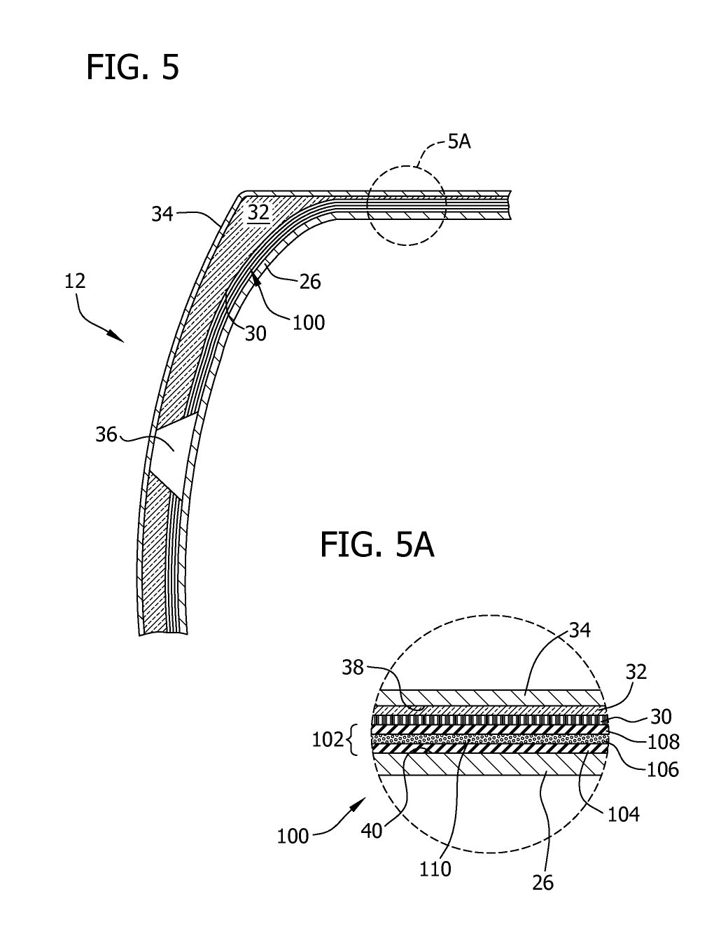

FIG. 5 is a partial cross-sectional view of an exemplary containment system 100 for use with high-pressure tanker railcar 10 (shown in FIG. 1) taken at section A. FIG. 5A is an enlarged schematic illustration of a portion of containment system 100 taken at section 5A. In FIG. 5, containment system 100 is containment system 28 (shown in FIG. 1). In the exemplary embodiment, containment system 100 is a self-sealing coating 102 that is applied to outer surface 40 of inner tank 26. More specifically, self-sealing coating 102 is configured to allow a projectile to pass through self-sealing coating 102 and inner tank 26 and to self-seal an opening through self-sealing coating 102 caused by the projectile. Self-sealing coating 102 is also configured to seal about stand-offs 36. In one embodiment, self-sealing coating 102 replaces fire retardant layer 30 and/or insulation layer 32 due to the fire retardant and/or insulation properties of self-sealing coating 102. For example, in a particular embodiment, the materials forming self-sealing coating 102 are selected and/or configured to provide a desired insulation rating and/or level for inner tank 26.

In the exemplary embodiment, self-sealing coating 102 is a urethane coating and includes a plurality of layers. In one embodiment, self-sealing coating 102 is a Battle Jacket® coating (“Battle Jacket” is a registered trademark of High Impact Technology of Tigard, Oreg.). Alternatively, self-sealing coating 102 is Dragonshield HT® (“Dragonshield HT” is a registered trademark of Specialty Products, Inc. of Lakewood, Wash.), Dragonshield BC™ (“Dragonshield BC” is a trademark of Specialty Products, Inc. of Lakewood, Wash.), and/or any other suitable self-sealing coating. More specifically, in the exemplary embodiment, self-sealing coating 102 includes a basecoat 104, an encapsulation layer 106, and a topcoat 108. Basecoat 104 and topcoat 108 each include an elastomer material, such as a polyurethane elastomer. Encapsulation layer 106 includes reactive beads 110 suspended in the elastomer material. Reactive beads 110 include a chemical selected to react with a material within tank 12 to form a solid within self-sealing coating 102. When an organic compound is stored within tank 12, reactive beads 110 can be, for example, Imbiber Beads® (“Imbiber Beads” is a registered trademark of Imbibitive Technologies Corporation of Midland, Mich.). In the exemplary embodiment, the materials used to form basecoat 104, encapsulation layer 106, reactive beads 110, and topcoat 108 are selected based on a material stored within tank 12 and/or based on a desired insulation rating and/or level.

More specifically, reactive beads 110 are selected to be used as the basis of the self-sealing of self-sealing coating 102. Reactive beads 110 are spray encapsulated into encapsulation layer 106 and, when exposed to the material within tank 12, reactive beads 110 swell into a solid. As such, the material of reactive beads 110 acts in conjunction with the material of the basecoat 104, encapsulation layer 106, and/or topcoat 108 to tightly seal off the undesired entrance and/or exit holes in inner tank 26 created by a projectile. In the exemplary embodiment, elastomeric properties of self-sealing coating 102 allow a projectile to pass through self-sealing coating 102 such that self-sealing coating 102 immediately closes an opening formed by the projectile.

More specifically, shrinkage of self-sealing coating 102 caused during spray application creates a constrained-layer effect which shrinks inward after the projectile passes through self-sealing coating 102. During the passage of the projectile, the projectile dislodges and/or exposes reactive beads 110 to the material within tank 12. A pressure wave forces the material within tank 12 from inner tank 26 through the projectile opening to activate reactive beads 110. Reactive beads 110 then react with the material within tank 12 and form a permanent, solid plug thereby self-sealing the projectile opening. Additionally, or alternatively, a field repair patch kit can be applied to a larger projectile opening to seal tank 12. In the exemplary embodiment, self-sealing coating 102, and more specifically, reactive beads 110, is configured to react with a speed and force sufficient to form a solid plug for sealing the opening caused by the projectile in a high-pressure vessel such that the release of any hazardous material from tank 12 is minimized.

To manufacture high-pressure tanker railcar 10 having containment system 100, self-sealing coating 102 is applied to outer surface 40 of inner tank 26. More specifically, basecoat 104 is sprayed onto outer surface 40 of inner tank 26, encapsulation layer 106 with reactive beads 110 is sprayed onto basecoat 104, and topcoat 108 is sprayed onto encapsulation layer 106. In the exemplary embodiment, spray application of basecoat 104, encapsulation layer 106, and topcoat 108 shrinks self-sealing coating 102 as described above. Self-sealing coating 102 is removed from stand-offs 36 to provide a welding surface for outer jacket 34. Fire retardant layer 30 and insulation layer 32 are coupled about containment system 100. When containment system 100 has a desired insulation rating and/or level, insulation layer 32 is omitted. In the exemplary embodiment, outer jacket 34 is then coupled to inner tank 26 by coupling inner surface 38 of outer jacket 34 to stand-offs 36 using, for example, welding techniques. During welding of outer jacket 34 to stand-offs 36, containment system 100 is protected from the welding procedure.

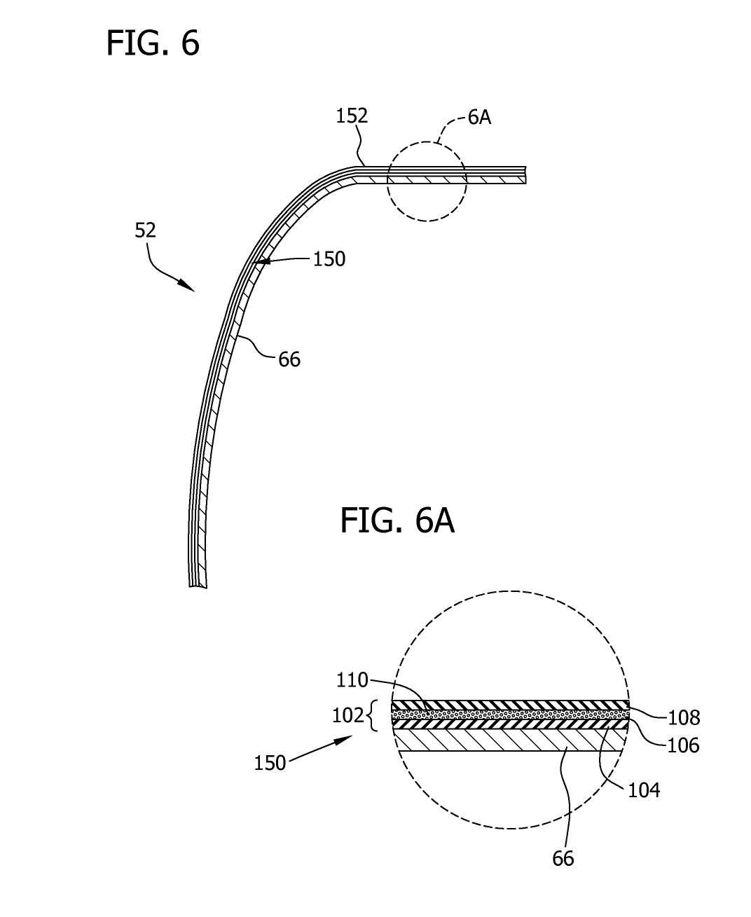

FIG. 6 is a partial cross-sectional view of an exemplary containment system 150 for use with low-pressure tanker railcar 50 (shown in FIG. 3) taken at section B. FIG. 6A is an enlarged schematic illustration of a portion of containment system 150 taken at section 6A. In FIG. 6, containment system 150 is containment system 68 (shown in FIG. 3). Containment system 150 is essentially similar to containment system 100 (shown in FIG. 5) and, as such, similar components are labeled with similar references. Containment system 150 forms an outer surface 152 of tank 52, rather than being positioned within an outer jacket, as is included with containment system 100. In the exemplary embodiment, topcoat 108 is selected to be paintable such that identifying markings can be applied to topcoat 108 for identifying low-pressure tanker railcar 50. Further, basecoat 104, encapsulation layer 106, and/or topcoat 108 can be selected to insulate inner tank 66.

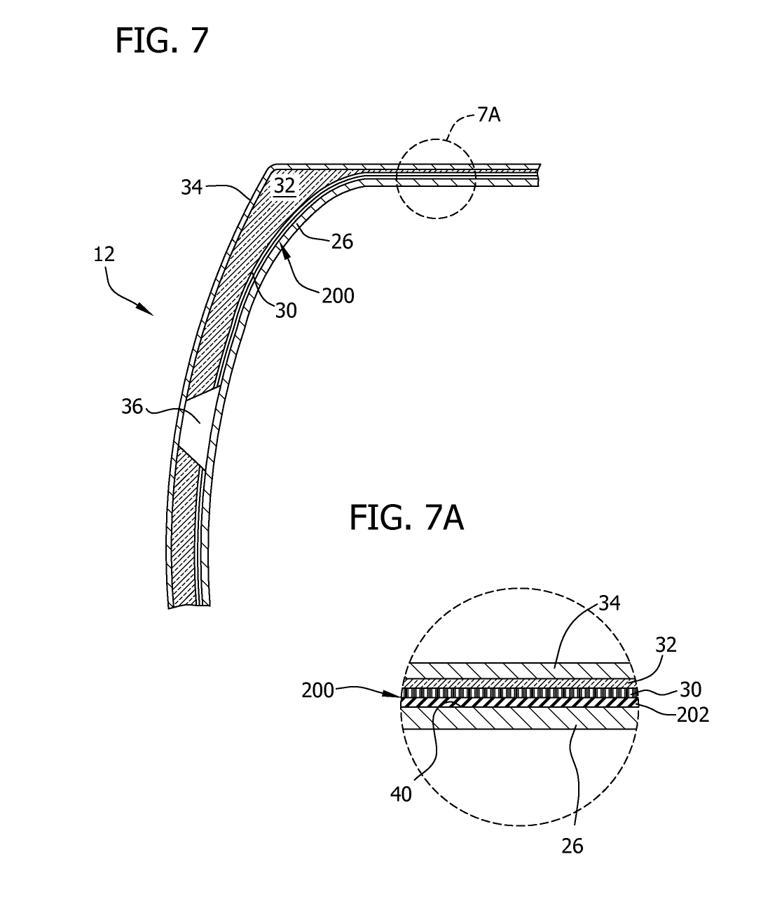

FIG. 7 is a partial cross-sectional view of a first alternative embodiment of a containment system 200 for use with high-pressure tanker railcar 10 (shown in FIG. 1) taken at section A. FIG. 7A is an enlarged schematic illustration of a portion of containment system 200 taken at section 7A. In FIG. 7, containment system 200 is containment system 28 (shown in FIG. 1). In the exemplary embodiment, containment system 200 includes a protective coating 202 that is coupled about outer surface 40 of inner tank 26. More specifically, protective coating 202 is configured to substantially resist penetration of inner tank 26 by a projectile and/or penetrating through inner tank 26. In one embodiment, protective coating 202 replaces fire retardant layer 30 and/or insulation layer 32 due to the fire retardant and/or insulation properties of protective coating 202. In an alternative embodiment, containment system 200 includes protective coating 202 and a metal layer adjacent protective coating 202.

In the exemplary embodiment, protective coating 202 is a single layer of protective material; however, protective coating 202 may include any suitable number of layers of protective material. Protective coating 202 is, for example, Kevlar® (“Kevlar” is a registered trademark of E.I. du Pont de Nemours and Company of Wilmington, Del.), ballistic fabric, aramid fiber, Spectra® fiber (“Spectra” is a registered trademark of Honeywell International Inc. of Morristown, N.J.), an energy absorbing and/or dispersing material, and/or any other material configured to prevent projectiles from passing therethrough.

To manufacture high-pressure tanker railcar 10 having containment system 200, protective coating 202 is wrapped about inner tank 26. Protective coating 202 is removed from stand-offs 36 to provide a welding surface for outer jacket 34. More specifically, holes and/or openings are cut through protective coating 202 for stand-offs 36, bolster assemblies 18 and 20 (shown in FIG. 1), and sill assemblies 14 and 16 (shown in FIG. 1). Fire retardant layer 30 and insulation layer 32 are coupled about containment system 200. When containment system 200 provides a desired insulation rating and/or level, insulation layer 32 is omitted. In the exemplary embodiment, outer jacket 34 is then coupled to inner tank 26 by coupling inner surface 38 of outer jacket 34 to stand-offs 36 using, for example, welding techniques. During welding of outer jacket 34 to stand-offs 36, containment system 200 is protected from the welding procedure.

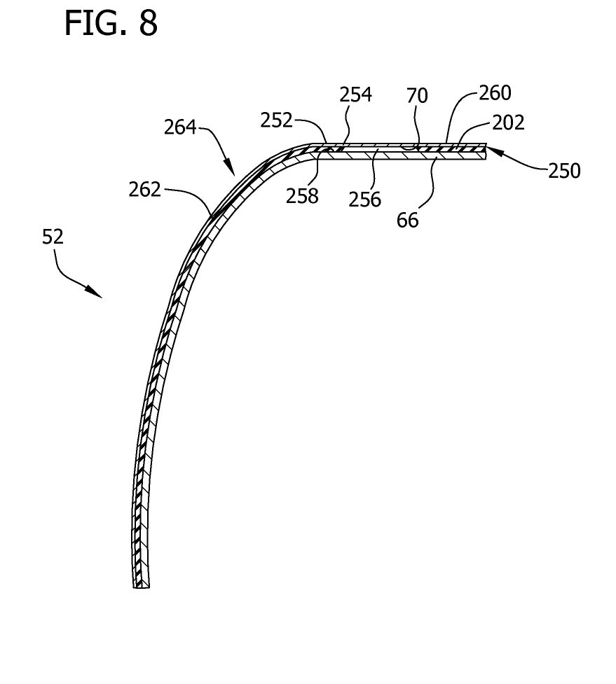

FIG. 8 is a partial cross-sectional view of a first alternative embodiment of a containment system 250 for use with the low-pressure tanker railcar 50 (shown in FIG. 3) taken at section B. In FIG. 8, containment system 250 is used as containment system 68 (shown in FIG. 3). Containment system 250 is essentially similar to containment system 200 (shown in FIG. 7) and, as such, similar components are labeled with similar references. Containment system 250 forms an outer surface 252 of tank 52, rather than being positioned within an outer jacket, as is included with containment system 200. In the exemplary embodiment, containment system 250 includes protective coating 202 and a metal layer 254. Protective coating 202 is any of the materials described above. Metal layer 254 is any suitable metal that facilitates preventing projectiles from reaching inner tank 66. Metal layer 254 and/or protective coating 202 is selected to be paintable such that identifying markings can be applied to metal layer 254 and/or protective coating 202 for identifying low-pressure tanker railcar 50. In particular embodiments, protective coating 202 and/or metal layer 254 are selected and/or configured to provide a desired insulation rating and/or level for inner tank 66.

Further, when using containment system 250, tank 52 includes stand-offs 256 welded to an outer surface 70 of inner tank 66 for supporting metal layer 254. To manufacture low-pressure tanker railcar 50 having containment system 250, protective coating 202 is wrapped about inner tank 66. Protective coating 202 is removed from stand-offs 256 to provide a welding surface for metal layer 254. More specifically, holes and/or openings are cut through protective coating 202 for stand-offs 256, bolster assemblies 58 and 60 (shown in FIG. 3), and sill assemblies 54 and 56 (shown in FIG. 3). Metal layer 254 is then coupled to inner tank 66 by coupling an inner surface 258 of metal layer 254 to stand-offs 256 using, for example, welding techniques. During welding of metal layer 254 to stand-offs 256, containment system 250 is protected from the welding procedure. Alternatively, metal layer 254 is coupled adjacent to outer surface 70 of inner tank 66, and protective coating 202 is wrapped about an outer surface 260 of metal layer 254 such that an outer surface 262 of protective coating 202 forms an outer surface 264 of tank 52. In such an embodiment, stand-offs 256 can be omitted.

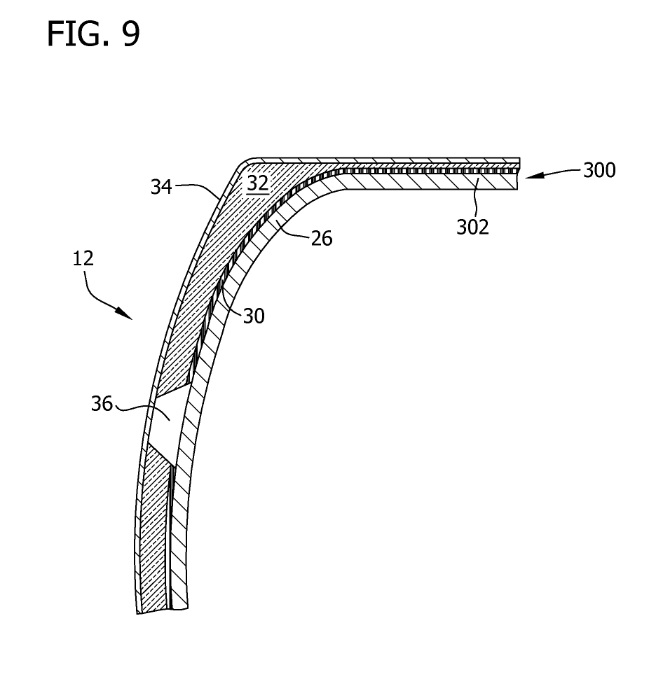

FIG. 9 is a partial cross-sectional view of a second alternative embodiment of a containment system 300 for use with high-pressure tanker railcar 10 (shown in FIG. 1) taken at section A. In FIG. 9, containment system 300 is containment system 28 (shown in FIG. 1). In the exemplary embodiment, containment system 300 includes armor that is formed integrally as one-piece with inner tank 26 to form an armored inner tank 302. More specifically, inner tank 26 is formed from the armor, such as ballistic steel armor, ballistic composite, and/or any other suitable ballistic resistant material, to produce armored inner tank 302. The armor is, for example, ATI 500-MIL™ steel (“ATI 500-MIL” is a trademark of ATI Allegheny Ludlum Corporation of Brackenridge, Pa.) and/or K12® Dual-Hardness Armor Plate material (“K12” is a registered trademark of ATI Allegheny Ludlum Corporation of Brackenridge, Pa.). Alternatively, the armor is coupled to inner tank 26 to form armored inner tank 302. For example, the armor is welded to inner tank 26 and/or wrapped about inner tank 26 to form armored inner tank 302. In an alternative embodiment, the armor is a ceramic armor, such as CeraShield™ armor ceramics (“CeraShield” is a trademark of CoorsTek, Inc. of Golden, Colo.), and/or a laminate armor, such as Armormax®, (“Armormax” is a registered trademark of International Armoring Corporation of Ogden, Utah), that is coupled about inner tank 26 to form armored inner tank 302.

In the exemplary embodiment, a material used to form armored inner tank 302 is selected based on weldability and/or formability. More specifically, the material used for the armor is able to be formed into sections of high-pressure tanker railcar 10 and welded to other sections of high-pressure tanker railcar 10. To manufacture high-pressure tanker railcar 10 having containment system 300, the armor is formed into elliptical heads 44 (shown in FIG. 1) and cylindrical sections 46 (shown in FIG. 1) by a cold forming and/or a hot forming process. When using a cold forming process, the armor is cold rolled into a plate and cut using, for example, a water jet and/or high definition plasma. At least two plates are formed into elliptical heads 44, which each include a cylindrical flange. Sections 46 are welded together to form a tube 48 (shown in FIG. 1), and cylindrical flanges of heads 44 are welded to ends of tube 48 to form armored inner tank 302. Stand-offs 36 are welded to the armor.

Alternatively, inner tank 26 is formed using conventional methods and/or techniques, and the armor is formed to conform to outer surface 40 (shown in FIG. 2) of inner tank 26. The armor is then welded or otherwise coupled to outer surface 40 of inner tank 26 to form armored inner tank 302, and stand-offs 36 are welded to the armor. In an alternative embodiment, inner tank 26 is formed using conventional methods and/or techniques and the armor is formed integrally as one-piece with outer jacket 34.

In the exemplary embodiment, fire retardant layer 30 and insulation layer 32 are coupled about containment system 300. Outer jacket 34 is then coupled to armored inner tank 302 by coupling inner surface 38 of outer jacket 34 to stand-offs 36 using, for example, welding techniques. During welding of outer jacket 34 to stand-offs 36, containment system 300 is protected from the welding procedure. Alternatively or additionally, an armored outer jacket is coupled to inner tank 26 at stand-offs 36.

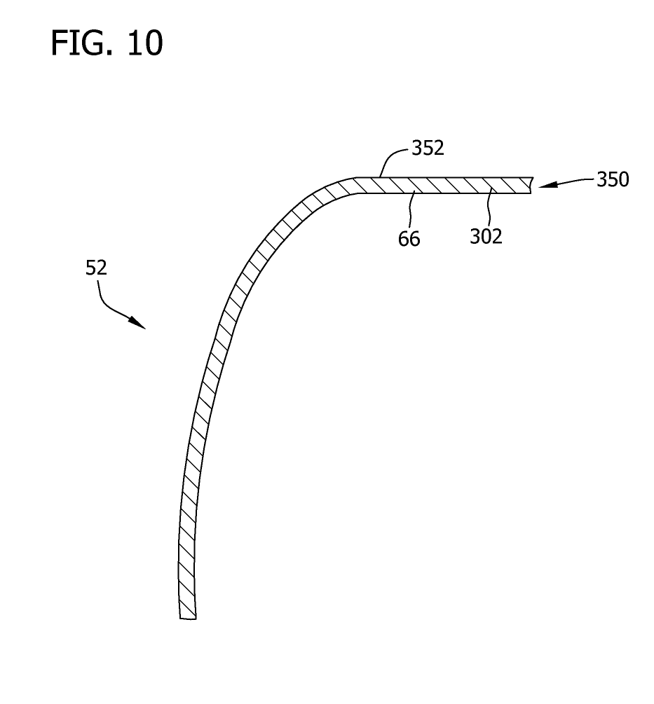

FIG. 10 is a partial cross-sectional view of a second alternative embodiment of a containment system 350 for use with low-pressure tanker railcar 50 (shown in FIG. 3) taken at section B. In FIG. 10, containment system 350 is containment system 68 (shown in FIG. 3). Containment system 350 is essentially similar to containment system 300 (shown in FIG. 9) and, as such, similar components are labeled with similar references. Containment system 350 includes armored inner tank 302 that forms an outer surface 352 of tank 52. In the exemplary embodiment, the armor is selected to be paintable such that identifying markings can be applied to the armor for identifying low-pressure tanker railcar 50.

Referring to FIGS. 1-10, it should be understood that containment system 28 and/or containment system 68 can include one or more of self-sealing coating 102, protective coating 202, and/or armor 302 within a single railcar 10 or 50, respectively. Further, any containment system 28, 68, 100, 150, 200, 250, 300, and/or 350 described herein can be configured to provide a desired insulation rating and/or level for inner tank 26 and/or 66.

The embodiments described herein facilitate preventing the release of a material stored within a tanker railcar. More specifically, by self-repairing projectile openings in an inner tank of a tanker railcar and/or by substantially resisting penetration of the inner tank by a projectile, the above-described containment systems facilitate preventing the release of materials into the environment. The containment systems described herein can be used with high-pressure tanker railcars and/or with low-pressure tanker railcars. When used with high-pressure tanker railcars, the above-described containment systems may replace and/or supplement fire-proofing and/or insulation layers. When used with low-pressure tanker railcars, the above-described containment systems can be retrofit onto, or used to build, the tank of the railcar.

The self-sealing coating described herein not only facilitates preventing the release of materials from the inner tank, but also provides vibration and acoustic damping, thermal insulation, and additional structural integrity to the tank. Further, the above-described self-sealing coating is configured to react with a material being stored within a tank so that when a projectile punctures an inner tank wall, the material stored within the tank comes into contact with the self-sealing coating and causes the material of the self-sealing coating to expand and plug the opening caused by the projectile.

Exemplary embodiments of containment systems for use with railcars are described above in detail. The containment systems are not limited to the specific embodiments described herein, but rather, components of systems and/or steps of the methods may be utilized independently and separately from other components and/or steps described herein. For example, the containment systems may also be used in combination with other railcars, and are not limited to practice with only the tanker railcars as described herein. Rather, the exemplary embodiment can be implemented and utilized in connection with many other containment applications.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A pressurized tanker railcar comprising:
an inner tank configured to contain a substance therein;
an outer jacket configured to define an outer surface of the pressurized tanker railcar; and
a containment system positioned between the inner tank and the outer jacket, the containment system coupled to the inner tank and configured to at least one of substantially resist penetration of the inner tank by a projectile and seal an opening formed by the projectile penetrating the inner tank.

2. A pressurized tanker railcar in accordance with claim 1 wherein the containment system comprises a self-sealing coating applied to the inner tank, the seal-sealing coating configured to self-seal an opening formed by a projectile penetrating at least one of the self-sealing coating and the inner tank.

3. A pressurized tanker railcar in accordance with claim 2 wherein the self-sealing coating comprises a plurality of layers including a first layer comprising a material configured to react with the substance within the inner tank after the inner tank is penetrated by the projectile.

4. A pressurized tanker railcar in accordance with claim 1 wherein the containment system comprises a protective coating coupled about the inner tank, the protective coating configured to substantially resist penetration of the inner tank by the projectile.

5. A pressurized tanker railcar in accordance with claim 1 wherein the containment system comprises armor used to form the inner tank, the armor configured to substantially resist penetration of the inner tank by the projectile.

6. A pressurized tanker railcar in accordance with claim 1 wherein the containment system is configured to provide a desired insulation rating for the inner tank.

7. A pressurized tanker railcar in accordance with claim 1 further comprising a fire retardant layer positioned between the containment system and the outer jacket.

8. A pressurized tanker railcar in accordance with claim 1 further comprising an insulation layer positioned between the containment system and the outer jacket.

9. A pressurized tanker railcar in accordance with claim 1, wherein the inner tank is a high-pressure tank configured to be pressurized to between about 165 pounds per square inch (psi) and about 700 psi above atmospheric pressure.

10. A method for forming a pressurized tanker railcar, the method comprises:
providing an inner tank configured to contain a substance therein;
coupling a containment system about the inner tank, the containment system configured to at least one of substantially resist penetration of the inner tank by a projectile and seal an opening formed by the projectile penetrating the inner tank; and
coupling an outer jacket about the containment system, the outer jacket defining an outer surface of the pressurized tanker railcar.

11. A method in accordance with claim 10, wherein coupling a containment system about the inner tank comprises spray applying a self-sealing coating to the inner tank, the seal-sealing coating configured to self-seal an opening formed by a projectile penetrating at least one of the self-sealing coating and the inner tank.

12. A method in accordance with claim 11, wherein spray applying a self-sealing coating to the inner tank comprises spray applying a plurality of layers to the inner tank including a first layer that includes a material configured to react with the substance within the inner tank after the inner tank has been penetrated by the projectile.

13. A method in accordance with claim 11, wherein spray applying a self-sealing coating to the inner tank comprises spray applying a self-sealing coating that provides a desired insulation rating for the inner tank.

14. A method in accordance with claim 10, wherein coupling a containment system about the inner tank comprises coupling a protective coating about the inner tank, the protective coating configured to substantially resist penetration of the inner tank by the projectile.

15. A method in accordance with claim 14, wherein coupling a protective coating about the inner tank comprises coupling a protective coating about the inner tank that provides a desired insulation rating for the inner tank.

16. A method in accordance with claim 10, wherein coupling a containment system about the inner tank comprises coupling armor to the inner tank, the armor configured to substantially resist penetration of the inner tank by the projectile.

17. A method in accordance with claim 10 further comprising positioning a fire retardant layer between the containment system and the outer jacket.

18. A method in accordance with claim 10 further comprising positioning an insulation layer between the containment system and the outer jacket.

19. A pressurized tanker railcar comprising:
an inner tank configured to contain a substance therein; and
a containment system positioned about the inner tank, the containment system coupled to the inner tank and configured to at least one of substantially resist penetration of the inner tank by a projectile and seal an opening formed by the projectile penetrating the inner tank.

20. A pressurized tanker railcar in accordance with claim 19, wherein the containment system is further configured to provide a desired insulation rating for the inner tank.
